(19) United States
(12) Patent Application Publication
(10) Pub. No.: US 2014/0359659 A1
(43) Pub. Date: Dec. 4, 2014

(54) DISPLAY CONTROLLER, DOCUMENT MANAGEMENT SERVER, AND BROADCAST TRANSMITTER

(71) Applicant: KABUSHIKI KAISHA TOSHIBA, Tokyo (JP)

(72) Inventor: Takayasu Tsuchiuchi, Sagamihara-shi (JP)

(73) Assignee: KABUSHIKI KAISHA TOSHIBA, Tokyo (JP)

(21) Appl. No.: 14/199,798

(22) Filed: Mar. 6, 2014

(30) Foreign Application Priority Data
Jun. 3, 2013 (JP) 2013-117365

(51) Int. Cl. H04N 21/458; H04N 21/431; H04N 21/81; H04N 21/234

(52) U.S. Cl. CPC H04N 21/458; H04N 21/23424; H04N 21/4316; H04N 21/812
USPC 725/34

(57) ABSTRACT

According to one embodiment, a display controller includes a receiver, a display, and an interface. The receiver receives address information indicative of a storage location of document information from a television receiver and receives the document information from the storage location. The document information is based on a broadcast signal. The display includes display areas. The display areas are based on structural information included in the document information received by the receiver, and the display displays at least one ad linked to a broadcast program in the broadcast signal with respect to at least one display area. The interface receives an operation to change information displayed with respect to the at least one display area from a first ad to a second ad.

### CROSS-REFERENCE TO RELATED APPLICATIONS

This application is based upon and claims the benefit of priority from Japanese Patent Application No. 2013-117365, filed Jun. 3, 2013, the entire contents of which are incorporated herein by reference.

### FIELD

Embodiments described herein relate generally to a display controller, a document management server, and a broadcast transmitter.

### BACKGROUND

Conventionally, there has been proposed a technique for providing various services to a user by combining broadcasting and communication. For example, there has been proposed a service in which, other than a program provided in broadcasting, content linked with the program is provided via a network such as the Internet. For example, it is conceivable to provide the relevant content to be browsed via the network with a portable information terminal such as a tablet device and a smartphone while the program provided in broadcasting is provided to a television receiver or the like.

The program provided in broadcasting is not limited to only video data, and for example, it is possible to superpose HTML document on the video data. The HTML document can include a script (computer program) such as JavaScript (registered trademark), and thus can be referred to as application document information. The application document information can be displayed as long as a device is connected to a network, and thus, other than television receivers, it can be displayed on portable information terminals. Furthermore, transmitting and receiving data between a portable information terminal and a television receiver can achieve collaborative operation.

According to the conventional technique, it is possible to realize displaying the advertizing information linked with a program provided in broadcasting by displaying the application document information. However, it has been difficult to change displayed information from advertizing information of a sponsor of the program to the advertizing information that match the user preference.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a configuration of a broadcast collaboration system according to an embodiment;

FIG. 2 is an exemplary block diagram of a hardware configuration of a broadcast delivery server in the embodiment;

FIG. 3 is an exemplary block diagram of a software configuration of the broadcast delivery server in the embodiment;

FIG. 4 is an exemplary block diagram of a hardware configuration of a television receiver in the embodiment;

FIG. 5 is an exemplary block diagram of a hardware configuration of a portable information terminal in the embodiment;

FIG. 6 is an exemplary diagram of an example of a screen of when the portable information terminal displays application document information, in the embodiment;

FIG. 7 is an exemplary diagram of an example of advertising information displayed in a first advertisement display area and in a second adverting display area in the embodiment;

FIG. 8 is an exemplary conceptual diagram illustrating the advertising information displayed in the second advertisement display area in the embodiment;

FIG. 9 is an exemplary diagram of an example of a portion of the application document information in the embodiment;

FIG. 10 is an exemplary diagram of an example of a portion of the application document information in the embodiment;

FIG. 11 is an exemplary diagram of an example of a portion of the application document information of when the advertising information is acquired via a public network in the embodiment;

FIG. 12 is an exemplary flowchart of a process of collaborative display performed in a television and program collaborative information display system in the embodiment;

FIG. 13 is an exemplary flowchart of a process of displaying the application document information on a first portable information terminal performed in the television and program collaborative information display system in the embodiment;

FIG. 14 is an exemplary flowchart of a process of display control for each display area performed in the first portable information terminal in the embodiment; and

FIG. 15 is an exemplary diagram illustrating the concept of transmitting statistical information in the broadcast collaboration system in the embodiment.

### DETAILED DESCRIPTION

In general, according to one embodiment, a display controller comprises a receiver, a display, and an interface. The receiver receives address information indicative of a storage location of document information from a television receiver and receives the document information from the storage location. The document information is based on a broadcast signal. The display comprises display areas. The display areas are based on structural information included in the document information received by the receiver, and the display is configured to display at least one ad linked to a broadcast program in the broadcast signal with respect to at least one display area. The interface receives an operation to change information displayed with respect to the at least one display area from a first ad to a second ad.

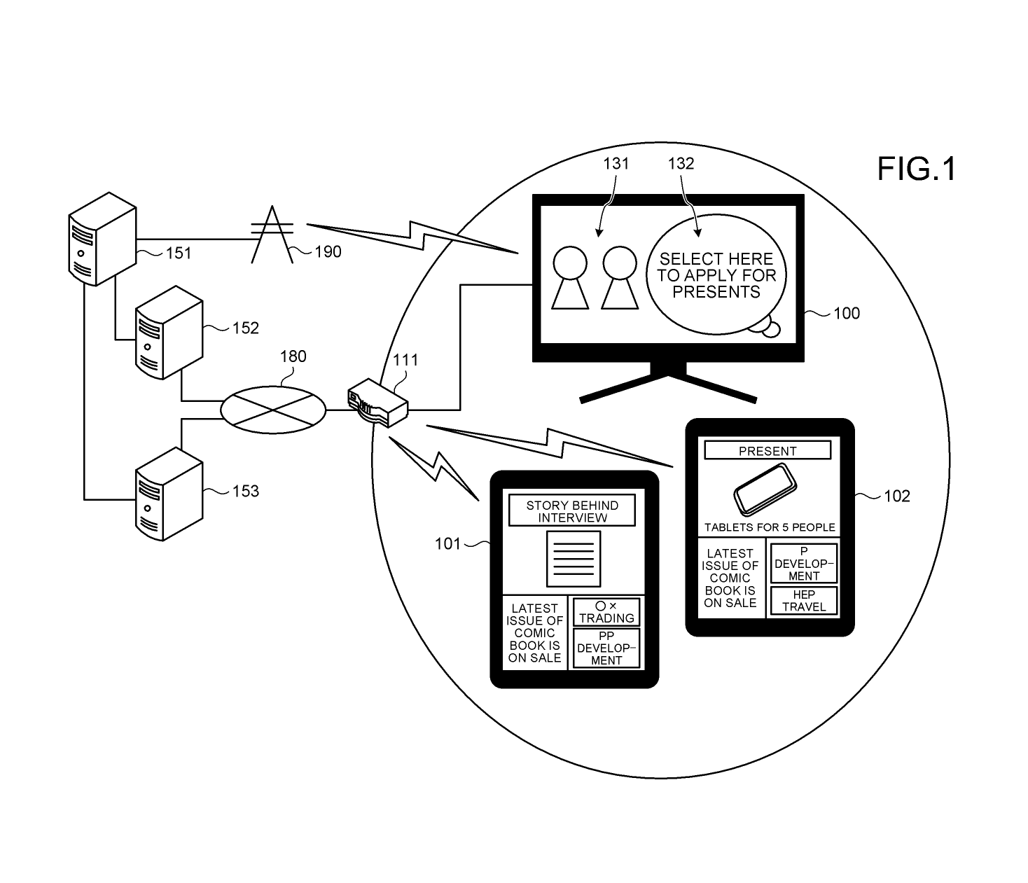

FIG. 1 is a block diagram illustrating a configuration of a broadcast collaboration system according to an embodiment. The broadcast collaboration system illustrated in FIG. 1 comprises a radio tower 190, a broadcast delivery server 151, a document management server 152, and an AIT information server 153. The broadcast collaboration system further comprises a home network at the end of a public network 180 to which the document management server 152 and the AIT information server 153 are connected.

The home network is structured as a local area network based on a router 111 and others. The local area network comprises the router 111, a television receiver 100, a first portable information terminal 101, and a second portable information terminal 102, and is connected to the public network 180 via the router 111.

The portable information terminals yield the use of zero or more devices at home. The television receiver 100 has a function to receive a broadcasting signal transmitted from the radio tower 190 and to display video included in the broadcasting signal. The television receiver 100 further has a browsing function to display information received via the public network 180. While the present embodiment is exemplified with the portable information terminal used as a display controller, the display controller may be other devices.

The portable information terminals 101 and 102 are terminals that can be operated with a touch panel screen or the like, and have a function to communicate with the television receiver 100 and with the public network 180 via the router 111.

The broadcast delivery server 151 performs processes concerning a broadcasting signal and application document information provided via a network. More specifically, the broadcast delivery server 151 generates the application document information to be displayed on the television receiver 100 and the portable information terminals 101 and 102, and performs a process to make the application document information accessible from the broadcasting signal.

The application document information in the embodiment comprises one or more display areas and is the data that displays a variety of content for each of the display areas. The content displayed in each display area includes any one or more of text, still image, and video. While the application document information is, for example, the document data that is described in HTML or XML and includes a script (computer program) such as JavaScript (registered trademark), the application document information only needs to be the data that can be acquired via a network and displayed on a portable information terminal or on a television receiver.

There is a tendency that the conventional style of watching television is changed by providing the television receiver 100 and the portable information terminals 101 and 102 at home. For example, it is conceivable that users operate the portable information terminals 101 and 102 while watching a program displayed on the television receiver 100.

For this reason, broadcast stations that provide programs are paying attention to the portable information terminals as a second screen. For example, broadcast stations consider the use of the portable information terminals as a device to complement a program or to increase the value of the program. Further, broadcast stations have been studying a method to make advertising information from a sponsor, who sponsors the program, available for browsing from the portable information terminals.

The television receiver 100 receives a broadcasting signal, and transmits and receives information via the public network 180. Meanwhile, the portable information terminals transmit and receive information via the public network 180. As in the foregoing, the method of propagating information for the portable information terminals 101 and 102 and that of the television receiver 100 are different. It is thus desirable that the portable information terminals 101 and 102 leverage the characteristics of communication to achieve collaboration with the program displayed on the television receiver 100. At that time, performing message communication between the portable information terminals 101 and 102 and the television receiver 100 enables the collaborative operation to be performed.

The system configured with the television receiver 100 and the portable information terminals 101 and 102 is defined as a television and program collaborative information display system.

The television receiver 100 can display, by the instructions of application document information read, video of a program and graphics by the application document information on the same screen. For example, by the description of the application document information, content 132 indicated in the application document information may be displayed on video 131 of a program in a superposed manner. Likewise, the portable information terminals 101 and 102 may operate in accordance with the application document information.

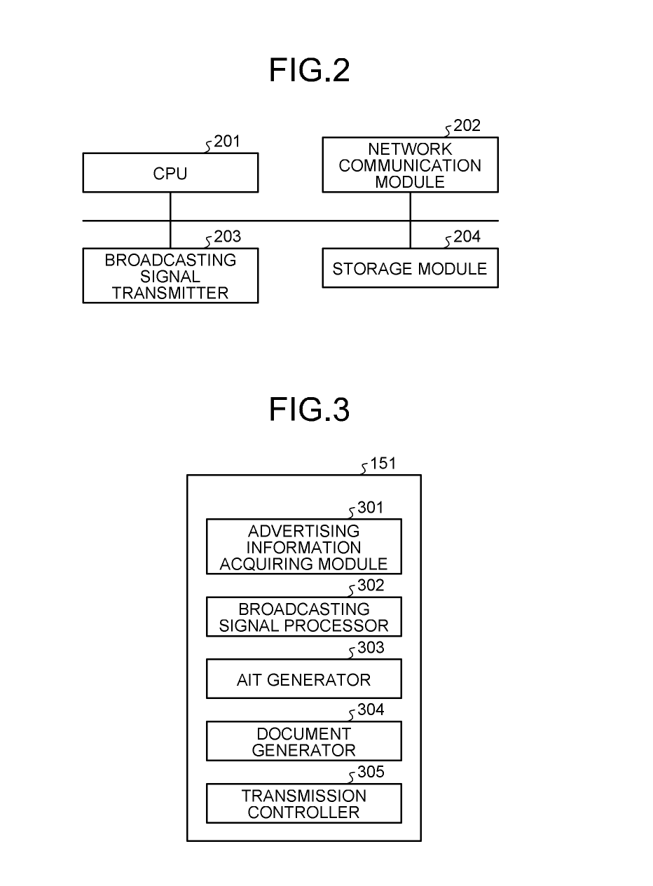

FIG. 2 is a block diagram illustrating a hardware configuration of the broadcast delivery server 151 in the embodiment. As illustrated in FIG. 2, the broadcast delivery server 151 comprises a CPU 201, a network communication module 202, a broadcasting signal transmitter 203, and a storage module 204. The broadcast delivery server 151 is a device installed for a broadcast station (delivery side) to deliver the broadcast.

The CPU 201 reads a computer program stored in the storage module 204, and performs a process to make the broadcasting signal and the application document information provided via the network collaborate with each other.

The network communication module 202 transmits and receives information to and from the document management server 152 and the AIT information server 153 connected via the network.

FIG. 3 is a block diagram illustrating a software configuration of the broadcast delivery server 151 in the embodiment. As illustrated in FIG. 3, the broadcast delivery server 151 comprises an advertising information acquiring module 301, a broadcasting signal processor 302, an AIT generator 303, a document generator 304, and a transmission controller 305.

The advertising information acquiring module 301 acquires the advertising information of the sponsor who sponsors the program of the broadcasting signal to transmit.

The document generator 304 generates application document information that contains the advertising information acquired and the content relevant to the program. In the embodiment, the application document information is not limited to contain the advertising information, and the application document information may contain a URL and such of an acquisition destination for the advertising information.

The AIT generator 303 generates an application information table (AIT) file indicative of a storage destination for the application document information generated by the document generator 304. The storage destination for the application document information in the embodiment is conceivable to be, for example, the document management server 152. Consequently, the AIT generator 303 in the embodiment generates the AIT information containing the URL indicative of the storage destination for the application document information in the document management server 152.

The AIT file is a file containing data to specify and control the application document information relevant to the program provided in the broadcasting signal. While the AIT file is exemplified to be provided from the AIT file server 153 in the embodiment, as long as the AIT file can be acquired by communication terminals at home (for example, the television receiver 100 and the portable information terminals 101, 102), the AIT file may be provided in any form.

The broadcasting signal processor 302 encodes video of a program to generate a broadcasting signal, embeds address information indicative of the storage destination for the AIT file generated for each program in the broadcasting signal of the program encoded, and then performs modulation to output to the radio tower 190. In the embodiment, the storage destination for the AIT file is the AIT information server 153. Consequently, the broadcasting signal processor 302 in the embodiment embeds, in the broadcasting signal, the URL indicative of the storage destination for the AIT file in the AIT information server 153. The broadcasting signal embedded with the URL is broadcasted from the broadcasting signal transmitter 203 via the radio tower 190. While it is exemplified that the address information indicative of the storage destination for the AIT file is embedded in the broadcasting signal in the embodiment, it is not limited to embed the address information, and the address information may be embedded in the broadcasting signal as the AIT information. Furthermore, a portion or the whole of the application document information may be embedded in the broadcasting signal.

The transmission controller 305 transmits the application document information generated by the document generator 304 to the document management server 152. The transmission controller 305 further transmits the AIT file generated by the AIT generator 303 to the AIT file server 153.

The broadcasting signal transmitter 203 of the broadcast delivery server 151 then broadcasts the broadcasting signal, in which the address information indicative of the storage destination for the AIT file is embedded, through the radio tower 190.

The document management server 152 and the AIT file server 153 has a hardware configuration illustrated in FIG. 2 with the broadcasting signal transmitter 203 removed, and more specifically, has a configuration comprising the CPU 201, the network communication module 202, and the storage module 204.

The AIT file server 153 is a server that provides the AIT files to other communication devices.

The storage module 204 of the AIT file server 153 stores therein the AIT files. When the network communication module 202 of the AIT file server 153 subsequently receives a request to transmit the AIT file from the other communication device, the CPU 201 reads out the AIT file corresponding to the currently broadcasted program from the storage module 204. The network communication module 202 then transmits the AIT file read out to the other communication device.

The document management server 152 is a server that provides the application document information to other communication devices.

The storage module 204 of the document management server 152 stores therein the application document information. When the network communication module 202 of the document management server 152 subsequently receives a request to transmit the application document information from the other communication device, the CPU 201 reads out the application document information corresponding to the transmission request from the storage module 204. The network communication module 202 then transmits the application document information read out to the other communication device.

In the present embodiment, the system configured with the broadcast delivery server 151, the document management server 152, and the AIT file server 153 is defined as a broadcast delivery system. While the system is exemplified to be configured with three apparatuses of the broadcast delivery server 151, the document management server 152, and the AIT file server 153 in the embodiment, it is not limited to three apparatuses, and the system may be configured with two apparatuses or less or with four apparatuses or more as long as the above-described configuration is provided.

The system configured with the television and program collaborative information display system and the broadcast delivery system is defined as a broadcast collaboration system.

The following describes a configuration of the television and program collaborative information display system provided in a network at home. In the embodiment, transmitting and receiving data between the television receiver 100 and the portable information terminals 101 and 102 achieve collaborative display of the program and the application document information displayed.

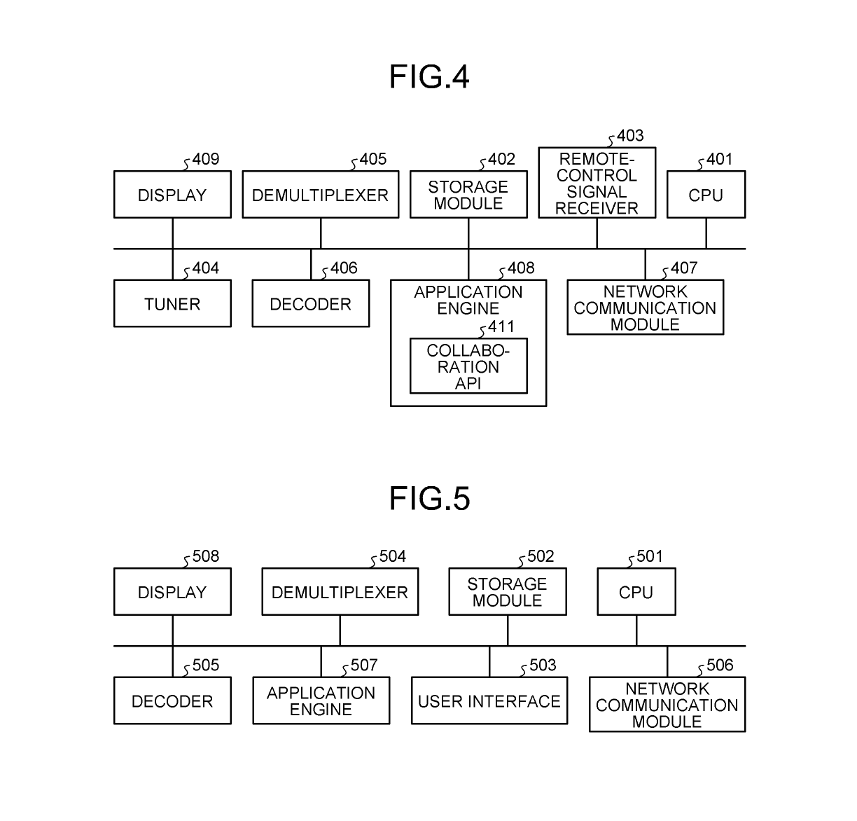

FIG. 4 is a block diagram illustrating a hardware configuration of the television receiver 100 in the embodiment. As illustrated in FIG. 4, the television receiver 100 comprises a CPU 401, a storage module 402, a remote-control signal receiver 403, a tuner 404, a demultiplexer 405, a decoder 406, a network communication module 407, an application engine 408, and a display 409.

The storage module 402 stores therein a variety of data including computer programs. The CPU 401 executes the computer programs stored in the storage module 402 other than performing various calculations and processes.

The remote-control signal receiver 403 receives operating information by infrared light from a remote controller (not illustrated) via an infrared light receiver (not illustrated). The CPU 401 then controls the respective modules of the television receiver 100 based on the operating information received.

The tuner 404 receives the selection of a desired channel based on the operating information received by the remote-control signal receiver 403, and receives the broadcasting signal selected via an antenna (not illustrated). The tuner 404 then outputs the broadcasting signal received to the demultiplexer 405.

The demultiplexer 405 separates the broadcasting signal received by the tuner 404 into content information concerning the broadcasting signal and encrypted video data. The content information separated may contain the address information indicating the storage destination for the above-described AIT file (for example, a URL of the AIT file server 153).

The decoder 406 decodes the encrypted video data. The content information separated and the video data decoded are output to the display 409.

The network communication module 407 transmits and receives data to and from the document management server 152 and the AIT file server 153 via the router 111. Furthermore, the network communication module 407 transmits and receives data to and from the first portable information terminal 101 and the second portable information terminal 102 via a wired or wireless communication line.

For example, when the content information separated by the demultiplexer 405 contains a URL of the AIT file server 153 indicating the storage destination of the AIT file, the network communication module 407 receives the AIT file corresponding to the currently broadcasted program from the URL (the URL of the AIT file server 153). Furthermore, after the CPU 401 reads the received AIT file, the network communication module 407 receives the application document information in accordance with control information included in the AIT file. Regarding the timing to start receiving the AIT file, it is started automatically after it is determined that the AIT file is receivable or by user operation performed after the determination.

The application engine 408 comprises a collaboration API 411, and reads the application document information received to perform the control and display based on the application document information. The application engine 408 in the embodiment is conceivable to be a browser or the like that can process HTML files and XML files.

The collaboration API 411 is an API to make the portable information terminals connected via the network at home (for example, the first portable information terminal 101 and the second portable information terminal 102) and the application document information collaborate with each other. The collaboration API 411 in the embodiment is used to transmit a URL to be displayed by the portable information terminals (for example, the first portable information terminal 101 and the second portable information terminal 102) according to the application document information read by the application engine 408. Consequently, the displays can be collaborated between the television receiver 100 and the portable information terminals (for example, the first portable information terminal 101 and the second portable information terminal 102). Furthermore, the application document information acquired from the URL may be transferred, not transferring the URL, directly to the portable information terminals (for example, the first portable information terminal 101 and the second portable information terminal 102).

The display 409 is configured with a liquid crystal display panel or the like, and displays the video data decoded by the decoder 406 and the application document information processed by the application engine 408.

FIG. 5 is a block diagram illustrating a hardware configuration of the portable information terminals 101 and 102 in the embodiment. As illustrated in FIG. 5, each of the portable information terminals 101 and 102 comprises a CPU 501, a storage module 502, a user interface 503, a demultiplexer 504, a decoder 505, a network communication module 506, an application engine 507, and a display 508. While the portable information terminals 101 and 102 are defined as, for example, a tablet device and a smartphone, any device may be used as long as the device comprises a display and is portable.

The storage module 502 stores therein a variety of data including computer programs. The CPU 501 executes the computer programs stored in the storage module 502 other than performing various calculations and processes.

The demultiplexer 504 separates the information received via the public network 180 into content information and video data. The decoder 505 decodes the video data. When the video data is encrypted, the decoder 505 decodes the video data after performing a decryption process. The content information separated and the video data decoded are output to the display 508.

The network communication module 506 transmits and receives data to and from the document management server 152 via the router 111. Furthermore, the network communication module 506 transmits and receives data to and from the television receiver 100 via a wired or wireless communication line.

The application engine 507 reads application document information and performs the display control based on the application document information. The application engine 507 in the embodiment collaborates with the collaboration API 411 of the television receiver 100 via the network communication module 506 to acquire the application document information from the URL transferred from the collaboration API 411, and then displays the application document information acquired. The application engine 507 in the embodiment is conceivable to be, for example, a browser or the like that can process HTML files and XML files.

The display 508 is configured with a liquid crystal display panel or the like, and displays the video data decoded by the decoder 505 and the application document information processed by the application engine 507.

The user interface 503 is configured with a touch sensor film affixed on the surface of the display 508, and acquires coordinates of contact position on the display 508 as operating information of the user. More specifically, the touch sensor film has sensors lined in an X axis direction and in a Y axis direction, and when the user makes contact with the screen with his/her hand and finger, or a portable device and the like, the touch sensor film detects the contact of the foregoing and then outputs a detection signal containing the coordinates of the contact position to the CPU 501 as the operating information. Furthermore, the contact is not restricted to the actual contact, and a state of an object nearly contacting the display 508 may be regarded as the contact.

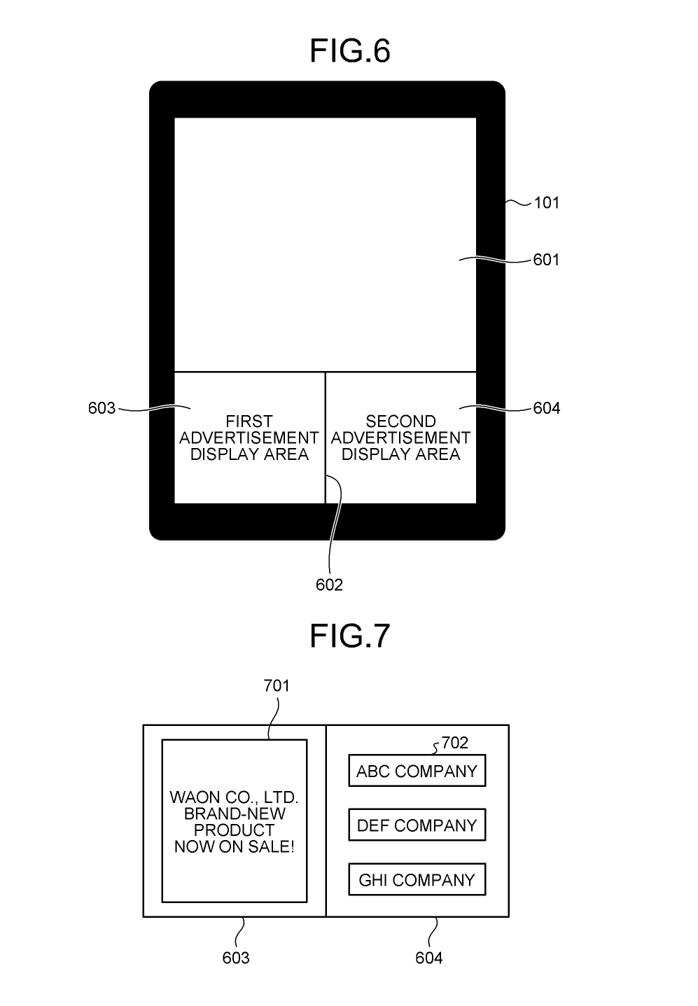

Next, there is described the application document information acquired by the application engine 507 based on the URL received from the collaboration API 411 of the television receiver 100. FIG. 6 is a diagram illustrating an example of a screen of when the portable information terminals 101 and 102 in the embodiment display the application document information. In the example illustrated in FIG. 6, the portable information terminals 101 and 102 display a screen including a main display area 601, a first advertisement display area 603, and a second advertisement display area 604. As illustrated in FIG. 6, the advertisement area in the embodiment comprises the first advertisement display area 603 and the second advertisement display area 604 with a border line 602 sandwiched therebetween.

The application document information in the embodiment comprises a plurality of display areas for displaying the advertisement collaborated with the currently broadcasted program. The display areas for advertisement (hereinafter, referred to as the advertisement display areas) can display advertising information different from one another.

FIG. 7 is a diagram illustrating an example of advertising information displayed on the first advertisement display area 603 and on the second advertisement display area 604 in the embodiment. On the first advertisement display area 603 illustrated in FIG. 7, advertising information provided by the sponsor of the program broadcasted by the broadcasting signal is changed and displayed in accordance with time, under the control by the script described in the application document information. In other words, advertisement linked with the progression of the program can be displayed. Consequently, the broadcast station can display the advertisement linked with the content of the program. While a banner 701 or the like for moving on to each piece of sponsor information is displayed as the advertising information in each advertisement display area in the example illustrated in FIG. 7, the information other than the banner may be displayed.

Meanwhile, from among a plurality of the advertising information (e.g., a banner 702) provided by the sponsor of the program, the second advertisement display area 604 changes the advertising information in response to the operation received from the user. For example, performing a flick operation in the second advertisement display area 604 of the respective portable information terminals 101 and 102 can change the displayed advertising information.

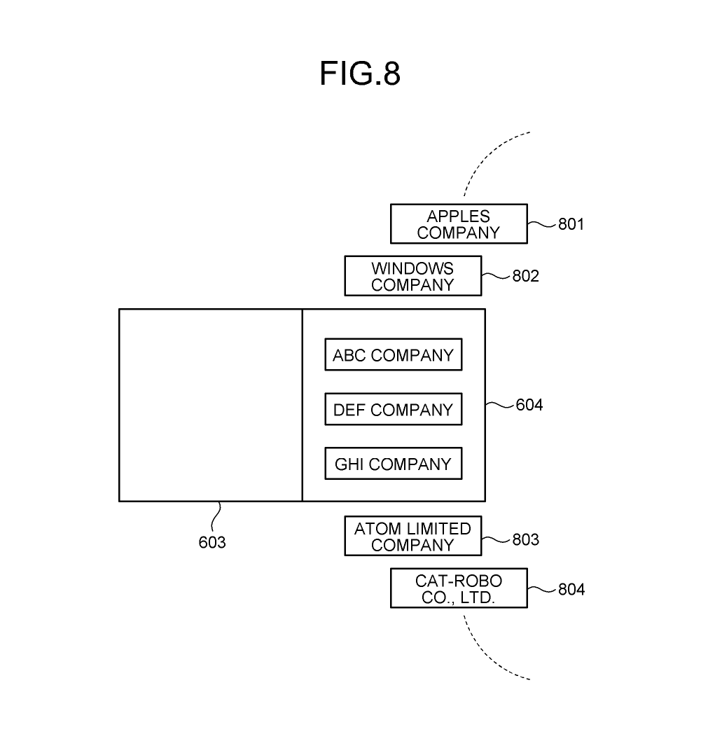

FIG. 8 is a conceptual diagram illustrating the advertising information displayed on the second advertisement display area 604. As illustrated in FIG. 8, the display of the pieces of advertising information by the sponsor of the program currently broadcasted is changed in response to the operation of the user as if the pieces of advertising information are arranged in a circular manner. As for the user operation, a flick operation to slide in the upward direction or in the downward direction switches the advertising information displayed.

For example, when the user makes a flick operation to slide in the upward direction, the currently displayed advertising information moves upward, and when the advertising information is moved further upward than the upper hem of the second advertisement display area 604, the advertising information disappears and other advertising information (for example, advertising information 803, 804) moves up from the lower hem of the second advertisement display area 604 to be displayed. In contrast, when the user makes a flick operation to slide in the downward direction, other advertising information (for example, advertising information 802, 801) moves down from the upper hem of the second advertisement display area 604 to be displayed.

More specifically, a user can select at least one piece of advertisement information in which he or she is interested from among a number of pieces of advertising information provided by a sponsor of a program, and display the selected advertisement information in the second advertisement display area 604 in the embodiment. Consequently, the user can access to the at least one piece of the advertising information in which he or she is interested from among the pieces of advertising information.

Furthermore, when the user interface 503 of the portable information terminal (the first portable information terminal 101, the second portable information terminal 102) receives the selection of advertising information displayed in the first advertisement display area 603 and in the second advertisement display area 604, the network communication module 506 receives the application document information relevant to the advertising information and the display 508 displays the application document information in the main display area 601. Consequently, the user can browse the detailed information relevant to the advertising information (detailed information provided by the sponsor) of the user interest.

At that time, in the embodiment, the storage module 502 of the portable information terminal (the first portable information terminal 101, the second portable information terminal 102) stores therein the operation performed with respect to the first advertisement display area 603 and with respect to the second advertisement display area 604 as history information.

While the advertisement display area is exemplified to be provided at two locations in the embodiment, it is not intended to limit the form of display area thereby and thus the advertisement display area may be provided at a single location or at three or more locations. The positions and forms of the display are mere examples, and are conceivable in various forms. While the portable information terminals 101 and 102 are exemplified to display the application document information as illustrated in FIG. 6 in the embodiment, the television receiver 100 may display the application document information.

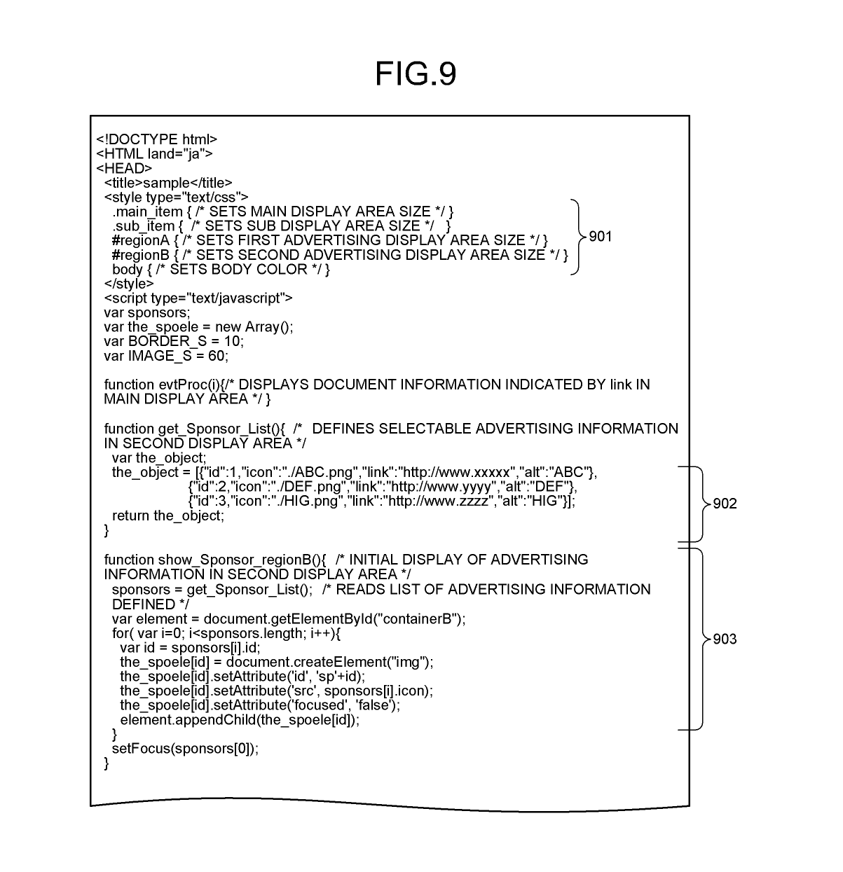

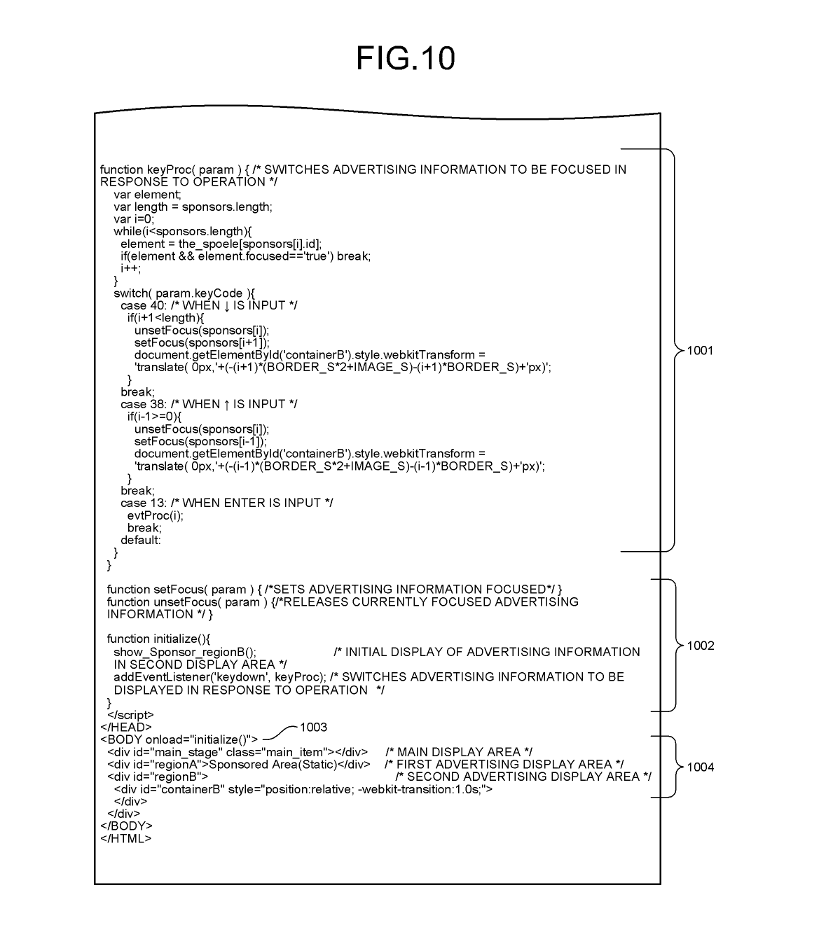

Next, the application document information, which achieves the above-described display, displayed by the portable information terminals 101 and 102 is described. FIGS. 9 and 10 are diagrams illustrating examples of the application document information.

The application document information illustrated in FIGS. 9 and 10 is generated by the broadcast delivery server 151 as the document information for portable information terminal collaboration, and then stored in the document management server 152. The television receiver 100 acquires the document information for portable information terminal collaboration from the document management server 152 according to the read out application document information, and then transfers the application document information for portable information terminal collaboration to the portable information terminals 101 and 102. A part of the source that is irrelevant to the second display area is omitted in order to simplify the explanation.

FIG. 9 is a diagram illustrating a part of the application document information. From among the application document information illustrated in FIG. 9, each line included in a range 901 defines the respective sizes of the main display area 601, the first advertisement display area 603, and the second advertisement display area 604. The detailed definitions are omitted. As for the method of definition, any method may be used such as defining the vertical and horizontal widths in units of pixels.

Each of the lines included in a range 902 defines the respective pieces of advertising information displayed in the second advertisement display area 604. While there are only three lines of advertising information described in the example illustrated in FIG. 9, there may be two lines or four or more lines of advertising information as long as the advertising information is provided by the sponsor of the program. In the advertising information illustrated in the range 902, other than the image information displayed in the second advertisement display area 604, described is the URL linked to the image information for the application document information displayed in the main display area 601 (that is the display area different from the second advertisement display area 604) when the selection of determining the advertising information is received.

In a range 903, there is defined a function indicating a process performed until the advertising information is initially displayed in the second advertisement display area 604. Executing the function displays the advertising information in the second advertisement display area 604.

FIG. 10 is a diagram illustrating a portion of the application document information. From among the application document information illustrated in FIG. 10, each of the lines included in a range 1001 defines the respective controlling performed when the operation is made in the second advertisement display area 604. More specifically, there is assumed controlling to be performed when a flick operation to slide in the upward direction, a flick operation to slide in the downward direction, or a tap (determining) operation is made. While the operating information received by the user interface 503 is exemplified to be substituted with the operation of the up or down cursor key and the determining key on a keyboard in the embodiment, any operation may be used as long as the operation is to move and determine. The explanation of the control when the respective operations are made is omitted as the respective control has already been described. As in the foregoing, in the application document information, defined is a function for the second advertisement display area 604 to receive the operation to switch the display to other advertising information out of the pieces of advertising information.

Each of the lines included in a range 1002 describes a function to be called when the application document information is read. More specifically, called out are a function to make an initial display when the advertising information is displayed in the second advertisement display area 604 and a function to switch the advertising display in the second advertisement display area 604 in response to the operation.

A range 1003 defines in the BODY tag that the function indicated in the range 1002 is processed when the application document information is read. Furthermore, a range 1004 defines the respective display areas when the application document information is displayed.

The application document information comprises the above-described descriptions, and thus the application engine 507 reading the application document information enables the display to be changed from the advertising information relevant to the program in response to the user operation made in the second advertisement display area 604.

In the examples illustrated in FIGS. 9 and 10, the advertising information to be displayed in the second advertisement display area 604 is written in advance. However, the embodiment is not limited thereto, and for example, the advertising information may be acquired via the public network 180.

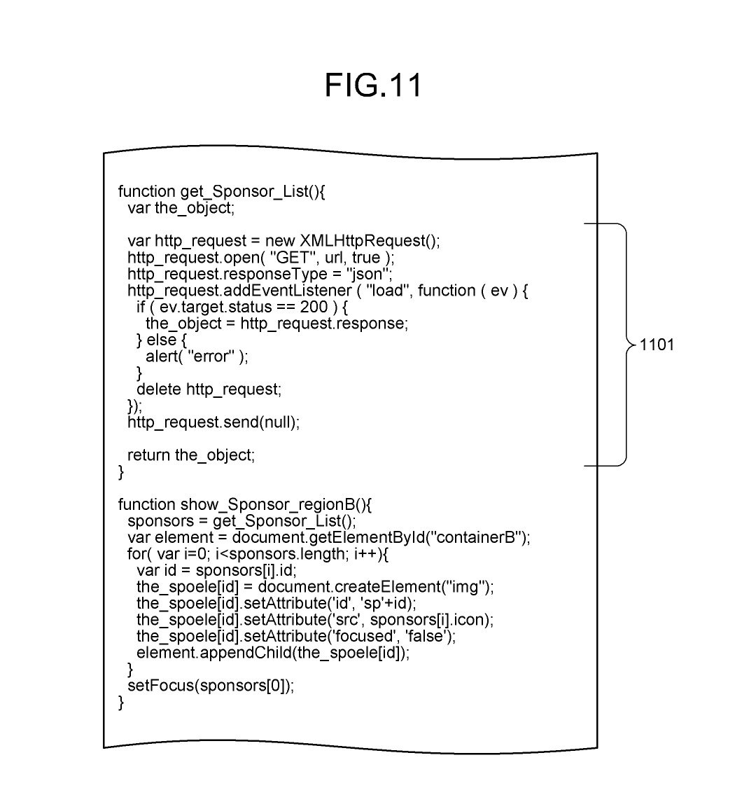

FIG. 11 is a diagram illustrating a portion of the application document information of when the advertising information is acquired via the public network 180. Among the application document information illustrated in FIG. 11, the script included in a range 1101 defines the process to acquire the advertising information.

The application document information illustrated in FIGS. 9 to 11 is illustrated by way of example only, and therefore, the application document information may be implemented in other forms. According to the present embodiment, as described above, the advertising information is changed in the first advertisement display area in accordance with time and the advertising information is changed in the second advertisement display area in response to the user operation. The display mode of the advertising information is determined when the broadcast delivery server 151 generates the application document information. In other words, the broadcast station side can determine the advertising information available to be displayed.

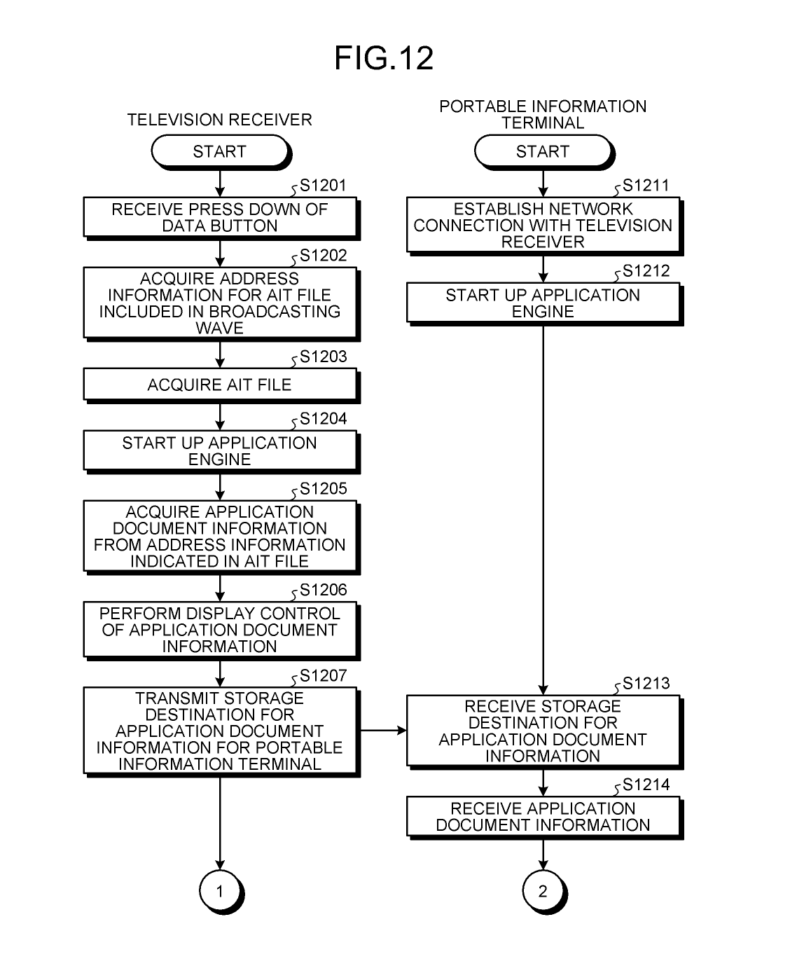

Next, it is described a process of collaborative display performed in the television and program collaborative information display system in the embodiment. FIG. 12 is a flowchart illustrating a procedure of the above-described process performed in the television and program collaborative information display system in the embodiment. While it is exemplified to make the television receiver 100 collaborate with the first portable information terminal 101 in the example illustrated in FIG. 12, the television receiver 100 is not limited to be collaborated with the first portable information terminal 101. That is to say, the television receiver 100 may collaborate with the second portable information terminal 102 in the same manner.

The remote-control signal receiver 403 of the television receiver 100 first receives the press down of a data button from the remote controller, and makes the document information received as data broadcast be displayed (S1201). In the embodiment, to display the document information received as data broadcast, a data broadcast browser (not illustrated) is assumed to be running.

When the remote-control signal receiver 403 receives from a user an operation to call for an API that commands application launching, such as an operation to receive selection of a banner urging application launching, the data broadcast browser acquires address information indicating the storage destination of an AIT file included in the argument of the API (S1202).

Subsequently, the network communication module 407 acquires the AIT file according to the acquired address information (S1203). The application engine 408 is then activated while receiving the storage destination for the application document information described in the acquired AIT file (S1204).

The network communication module 407 acquires the application document information based on the address information indicating the storage destination of the received application document information when the application engine 408 is activated (S1205). While the press down of the data button (a button to request the display of data broadcast) launches the data broadcast browser to activate the application engine 408 in the embodiment, the method for activating the application engine 408 is not limited to the user operation, and the application engine 408 may be activated in accordance with an activation instruction included in the broadcasting signal. In that case, there can be a flow without going through the data broadcast browser.

The application engine 408 then reads the acquired application document information and performs the display control of the application document information on the display 409 (S1206).

Meanwhile, the first portable information terminal 101 makes a network connection with the television receiver 100 during the first stage according to the user operation (S1211). The first portable information terminal 101 then activates the application engine 507 so as to perform collaboration in response to the user operation (S1212). Consequently, the first portable information terminal 101 is put in a standby state in which the program collaboration with the television receiver 100 is possible.

In the television receiver 100, the collaboration API 411 of the application engine 408 specifies the storage destination for the application document information for the first portable information terminal 101 in accordance with the application document read by the application engine 408, and transmits the storage destination (S1207). While the storage destination for the application document information indicates, for example, the storage area managed by the document management server 152, the storage destination may be a storage area of the television receiver 100 when the television receiver 100 has a function to download, store, and redistribute the application document information.

The application engine 507 of the first portable information terminal 101 then receives the storage destination for the application document information via the network communication module 506 (S1213). The application engine 507 subsequently receives the application document information from the storage destination via the network communication module 506 (S1214). As a consequence, the collaboration of the application document information between the television receiver 100 and the first portable information terminal 101 is achieved.

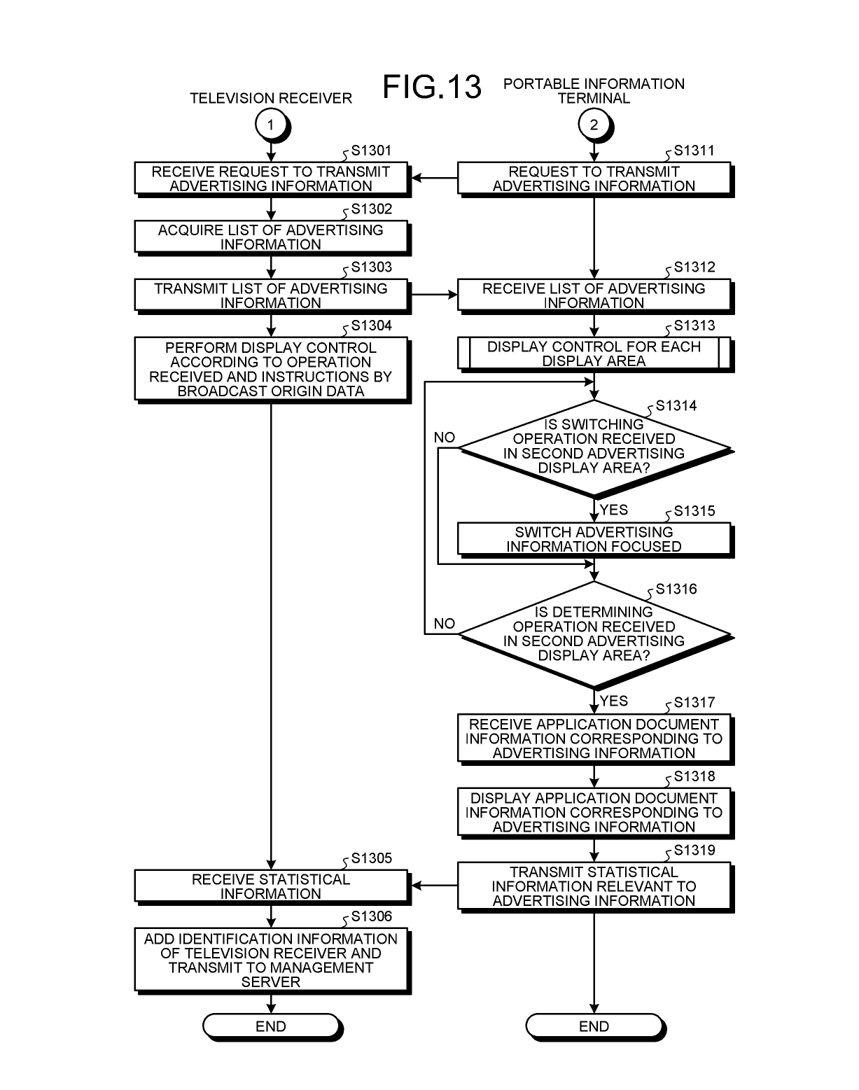

Next, a process to display the application document information is performed in the first portable information terminal 101. FIG. 13 is a flowchart illustrating a procedure of the above-described process performed in the television and program collaborative information display system in the embodiment.

The network communication module 506 of the first portable information terminal 101 first transmits a request to transmit advertising information to the television receiver 100 (S1311). The subject of advertising information for the transmission request is the advertising information not included in the application document information received at S1214 out of the advertising information to be displayed in the first advertisement display area 603 and in the second advertisement display area 604.

The network communication module 407 of the television receiver 100 then receives the request to transmit advertising information (S1301).

The network communication module 407 of the television receiver 100 acquires a list of advertising information from the storage destination for the advertising information described in the application document information (S1302).

The network communication module 407 of the television receiver 100 then transmits the list of advertising information acquired to the first portable information terminal 101 (S1303).

The network communication module 506 of the first portable information terminal 101 receives the list of advertising information from the television receiver 100 (S1312).

Meanwhile, the television receiver 100 performs display control of the program in the broadcasting signal and the application document information in response to the operation received from the remote controller and the instructions by broadcast origin data included in the broadcasting signal (S1304). The broadcast origin data is the data included in the data broadcasting signal to control the subject to display (content and application document information) in accordance with time.

In contrast, the network communication module 506 of the first portable information terminal 101 performs, based on the received list of advertising information and the acquired application document information, the display control for each of the display areas included in the application document information (S1313).

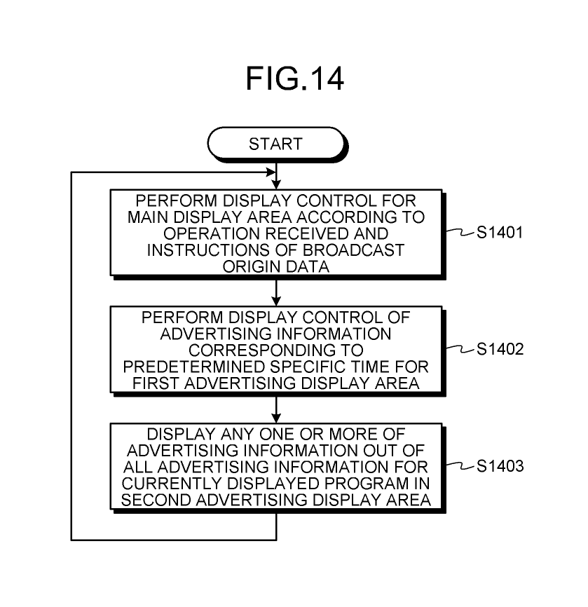

FIG. 14 is a flowchart illustrating a processing procedure of the display control for each display area performed in the first portable information terminal.

The application engine 507 of the first portable information terminal 101 first displays a main display area in accordance with the read out application document information, and then performs the display control on the display 409 for the main display area in accordance with the operation received and the instructions by the broadcast origin data (S1401).

Next, after the advertising information is initially displayed on the first advertisement display area 603 in accordance with the application document information, the application engine 507 controls the first advertising display area 603 to change the advertising information so that the advertising information corresponding to a predetermined time is controlled and displayed (S1402).

Subsequently, after the advertising information is initially displayed on the second advertising display area 604 in accordance with the application document information, the application engine 507 displays at least one of all of the pieces of advertising information of the program currently broadcasted on the second advertising display area 604 (S1403). Thereafter, the process is repeated from S1401 again.

Referring back to FIG. 13, after the display control for each display area is performed at S1313, the user interface 503 determines whether an operation to change the advertising information for the second advertisement display area 604 is received (S1314). When the operation to change the advertising information is not received (No at S1314), the process proceeds to S1316.

On the other hand, when the user interface 503 determines that the operation to change the advertising information for the second advertisement display area 604 is received (Yes at S1314), the application engine 507 changes the advertising information focused (displayed) in the second advertisement display area 604 (S1315).

The user interface 503 then determines whether a determining operation to select the advertising information for the second advertisement display area 604 is received (S1316). When the determining operation to select is not received (No at S1316), the process returns to S1314.

In contrast, when the user interface 503 determines that the determining operation to select the advertising information is received (Yes at S1316), the application engine 507 receives the application document information and the like corresponding to the advertising information (S1317). As for the method of acquiring the application document information, any method may be used.

The application engine 507 then displays the application document information and the like corresponding to the advertising information on the display 508 (S1318).

The application engine 507 then transmits the statistical information relevant to the advertising information to which the user referred and such to the television receiver 100 (S1319).

Meanwhile, the network communication module 407 of the television receiver 100 receives the statistical information from the first portable information terminal 101 (S1305). Likewise, the statistical information is received from the second portable information terminal 102.

The network communication module 407 of the television receiver 100 then adds the identification information of the television receiver 100 to the statistical information of the first portable information terminal 101 and the second portable information terminal 102 received, and transmits the statistical information to the document management server 152 that manages the statistical information (S1306). The transmission destination of the statistical information is not restricted to the document management server 152, and it only needs to be a server that manages the statistical information.

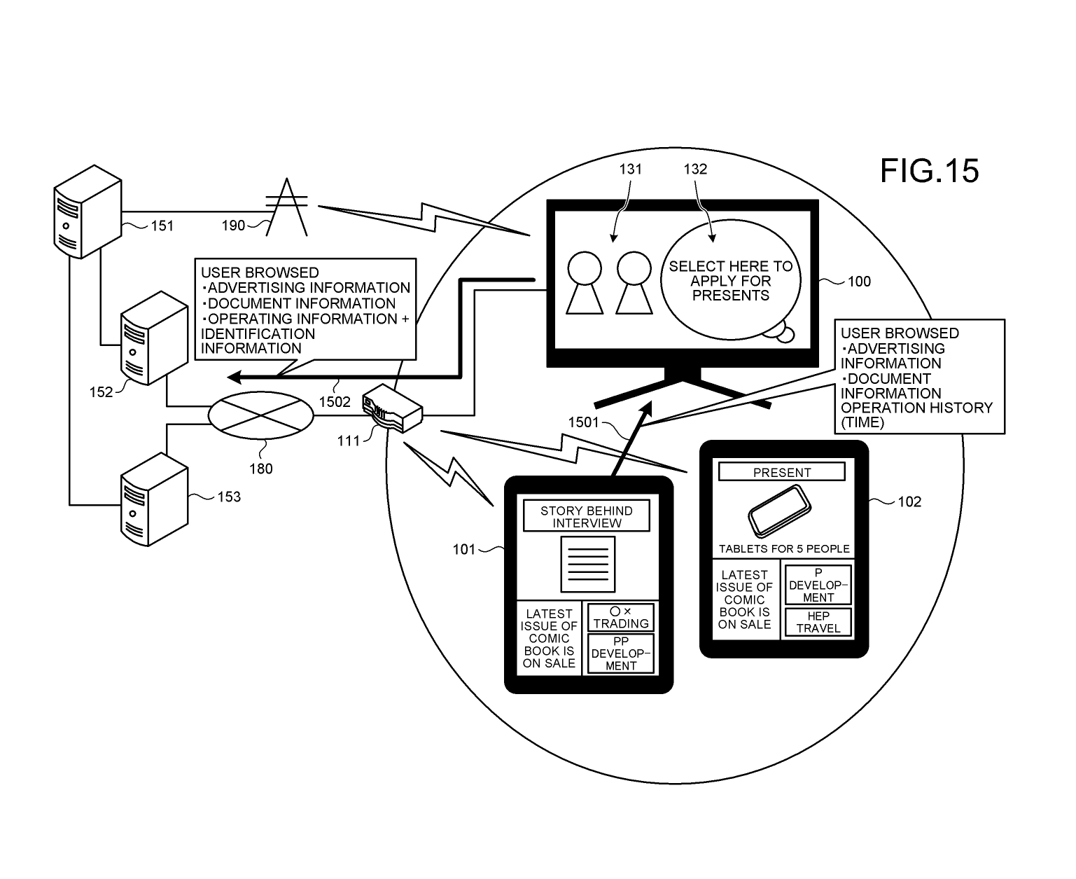

FIG. 15 is a diagram illustrating the concept of transmitting the statistical information in the broadcast collaboration system. In FIG. 15, the network communication module 506 of the first portable information terminal 101 transmits the advertising information that the user browsed, the application document information, and the operation history (for the advertising information and the application document information) (the operation history is the information of operating information and time information associated with each other) as the statistical information to the television receiver 100 (S1501).

The network communication module 407 of the television receiver 100 then adds the identification information of the television receiver 100 to the statistical information of the first portable information terminal 101 and the second portable information terminal 102 received (in other words, adding the identification of the television receiver 100 to the advertising information, the application document information, and the operation history), and transmits the statistical information to the document management server 152 (S1502).

In the present embodiment, the broadcast station side can manipulate the advertising information so that at least one piece of advertising information in which a user is interested is displayed from among a plurality of pieces of advertising information corresponding to a program. This improves probability of the user to refer to detailed information from the advertising information. As in the foregoing, an advertising model that is applied to the current business model of commercial broadcast stations can be achieved.

In the embodiment, the user is allowed to select a focused (displayed) piece of advertising information from pieces of advertising information provided by the broadcast station. Consequently, it becomes possible not to limit providing advertisement to an unspecified number of people in uniform manner over time.

Furthermore, the broadcast station can acquire the statistical information concerning the viewer who indicated the interest. The statistical information allows a specific number of accesses and activity information representing the operations made by the user during the program to be extracted by receiving the above-described statistical information from the respective television receivers. The broadcast station thus can check, other than the preference of the user by the statistical information, the influence of the program contributed to the advertising information from the activity information of the operations made during the program. Consequently, the added value contributed to the advertising information can be studied.

In the embodiment, the user can selectively display the advertising information of interest from among a plurality of pieces of advertising information provided by the sponsor of the program, without referring to the advertising information of no interest. Consequently, as compared to the case when the advertising information is changed in the chronological order, overlooking the advertising information of interest and such can be suppressed. Furthermore, while the program is on-air, moving from the advertising information of interest to the detailed information is easy, and thus guiding to the information provided by the sponsor is made easy.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display controller comprising:
a receiver configured to receive address information indicative of a storage location of document information from a television receiver and to receive the document information from the storage location, wherein the document information is based on a broadcast signal;
a display comprising display areas, wherein the display areas are based on structural information included in the document information received by the receiver, and the display is configured to display at least one ad linked to a broadcast program in the broadcast signal with respect to at least one display area; and
an interface configured to receive an operation to change information displayed with respect to the at least one display area from a first ad to a second ad.

2. The display controller of claim 1, wherein the display is configured to further changeably display, in accordance with time, a third ad with respect to one of the display areas different from the at least one display area.

3. The display controller of claim 1, wherein the display is configured to display information relevant to a third ad in one of the display areas different from the at least one display area when the interface receives determination to select the third ad.

4. A document management server comprising:
a receiver configured to receive a request for acquiring document information made with respect to the document management server from a receiver device configured to receive a broadcast signal comprising address information indicative of storage location of the document information or from a display controller that has received the address information from the receiver device: and
a transmitter configured to transmit the document information to the receiver device or to the display controller in accordance with the request, wherein the document information comprises structural information indicative of display areas and an operation to change an ad displayed with respect to at least one display area, and defines the ad configured to be displayed with respect to the at least one display area.

5. A broadcast transmitter comprising:
a broadcasting signal processor configured to embed address information for acquiring document information in a broadcast signal;
a document information generator configured to generate the document information by which content relevant to a program of the broadcasting signal and an ad are displayed in display areas different from each other and by which the displayed ad is changeable in accordance with an operation performed with respect to the display areas; and
a transmitter configured to transmit the document information generated by the document information generator to a storage destination based on the address information embedded in the broadcasting signal.
